(19) United States
(12) Patent Application Publication
(10) Pub. No.: US 2024/0009060 A1
(43) Pub. Date: Jan. 11, 2024

(54) LOWER BACK PAIN TREATMENT DEVICE

(71) Applicant: Hideo NAGATA, Aichi (JP)

(72) Inventor: Hideo NAGATA, Aichi (JP)

(21) Appl. No.: 18/036,539

(22) PCT Filed: Mar. 1, 2022
(86) PCT No.: PCT/JP2022/008649

§ 371 Date: May 11, 2023

(30) Foreign Application Priority Data
Mar. 1, 2021 (JP) 2021-031553

(51) Int. Cl. A61H 1/02

(52) U.S. Cl. CPC A61H 1/0292; A61H 2201/0149; A61H 2203/0431; A61H 2201/1676; A61H 2201/14; A61H 2201/1253

(57) ABSTRACT

A lower back pain treatment device includes a seat for sitting a patient thereon, the seat including a bottom part that is opposed to a sacrum and a coccyx of the patient and extends from a dorsal side to a ventral side of the patient, and a pair of side parts each of which is opposed to corresponding one of a pair of hipbones of the patient. The lower back pain treatment device includes a connecting part serving as a linking mechanism for linking the movement of the bottom part and the movement of the side parts. Action of the linking mechanism makes it possible to pressedly move the sacroiliac joint of the patient from a dorsal side to a ventral side, to move the front end upward, and to pressedly move up the tip of the coccyx toward the ventral side.

### TECHNICAL FIELD

The present disclosure relates to a lower back pain treatment device for treating lower back pain by moving the pelvis.

### BACKGROUND ART

Devices for performing pelvis correction have been heretofore known. For example, in Patent Document 1, an invention of a posture correcting device including a sacrum contact pad part and an ilium contact pad part is proposed, in which when the patient sits on, a raising moment acts on the sacrum pad part, and a forward-tilting moment acts on the ilium contact pad part, so that the posture of the patient is corrected.

### PRIOR ART LITERATURE

### Patent Documents

Patent Document 1
JP-A-2011-254878

### SUMMARY OF THE INVENTION

### Problems to be Solved by the Invention

The invention in Patent Document 1, however, just corrects the posture and has no influence on sacroiliac joints, and therefore any relaxation effect for lower back pain cannot be expected.

In contrast, the inventor has developed, in a clinical site for treating lower back pain, an operation by which a pair of hipbones are pressedly extended from a dorsal side to a ventral outside, and at the same time the end of a coccyx is pushed up toward the ventral side. However, in the actual clinical site, the operation is performed on a patient in the lateral decubitus position, therefore the left-side hipbone is extended from a dorsal side to a ventral outside in the right lateral decubitus position with the end of a coccyx being pushed up toward the ventral side, and then the right-side hipbone is extended from a dorsal side to a ventral outside in the left lateral decubitus position with the end of a coccyx being pushed up toward the ventral side, thus the operation cannot be linkingly done, which is problematic.

Under such situation, the present disclosure aims to provide a lower back pain treatment device which enable an operation by which the end of a coccyx is pushed up toward the ventral side of the patient while a pair of hipbones are extended from a dorsal side to a ventral outside.

### Means for Solving the Problems

A lower back pain treatment device according to the present disclosure comprises a seat for sitting a patient thereon, the seat including a bottom part that is opposed to a sacrum and a coccyx of the patient and extends from a dorsal side to a ventral side of the patient; and a pair of side parts each of which is opposed to corresponding one of a pair of hipbones of the patient; and a linking mechanism that is provided to link a movement of the side parts and a movement of the bottom part, wherein the linking mechanism tilts the side parts in such a manner to open towards both sides when the bottom part is tilted towards the dorsal side.

### Effects of the Invention

The lower back pain treatment device according to the present disclosure comprises a bottom part that is tiltable toward the dorsal side of the patient, side parts that is tilted from the dorsal side to ventral outside of the patient in response to a tilting movement of the bottom part, and a linking mechanism configured to link a movement of the side parts and a movement of the bottom part, wherein the linking mechanism tilts the side parts in such a manner to open towards both sides when the bottom part is tilted towards the dorsal side, therefore an operation to pressedly extend a pair of hipbones from a dorsal side to a ventral outside and an operation to push up the end of a coccyx toward the ventral side can be performed in parallel, to thereby exhibit an effect of relaxing muscle stress in muscles from around the femoral heads to the lumbar region through the buttocks so as to improve the low back pain.

### BRIEF DESCRIPTION OF THE DRAWINGS

FIG. 1 is a schematic view of a lower back pain treatment device according to Embodiment 1.

FIG. 2 is a right side view of the lower back pain treatment device in FIG. 1 and an enlarged view of the main part.

FIG. 3 is a rear view of the device, not showing a support pole in the rear of the device.

FIG. 4 is an explanatory diagram that shows motion and action of side parts.

FIG. 5 is an explanatory diagram that shows motion and action of a bottom part.

FIG. 6 is a plan view of a lower back pain treatment device according to Embodiment 2.

FIG. 7 is a bottom view of the device of the lower back pain treatment device in FIG. 6.

FIG. 8(a) is a side view of the side parts of the lower back pain treatment device in FIG. 6 and FIG. 8(b) is a side view of the bottom part of the lower back pain treatment device in FIG. 6.

FIG. 9 is an explanatory diagram that shows motion and action of side parts.

FIG. 10 is an explanatory diagram that shows motion and action of a bottom part.

FIG. 11 is a plan view of a lower back pain treatment device according to Embodiment 3.

FIG. 12 is an exploded perspective view of the lower back pain treatment device in FIG. 11.

FIG. 13(a) is a right side view of the lower back pain treatment device in FIG. 11 and FIG. 13(b) is a perspective right side view of the side parts of the lower back pain treatment device in FIG. 11.

FIG. 14 is a schematic diagram that shows a mechanism of the side parts of the lower back pain treatment device in FIG. 11.

FIG. 15 is a plan view of the lower back pain treatment device in FIG. 11.

FIG. 16 is an explanatory diagram that shows motion and action of side parts.

FIG. 17 is an explanatory diagram that shows motion and action of a bottom part.

### MODES FOR CARRYING OUT THE INVENTION

Hereinafter, Embodiments 1 through 3 that embody the lower back pain treatment device according to the present disclosure will be described with reference to the drawings. In the following description, the front side of a patient (ventral side) is defined as a front or forward side of the device, the rear side of the patient (dorsal side) is defined as a backside or rearward side of the device, a surface abutting on the body of the patient is defined as a treatment surface, and a reverse surface of the treatment surface is defined as a non-treatment surface.

### Embodiment 1

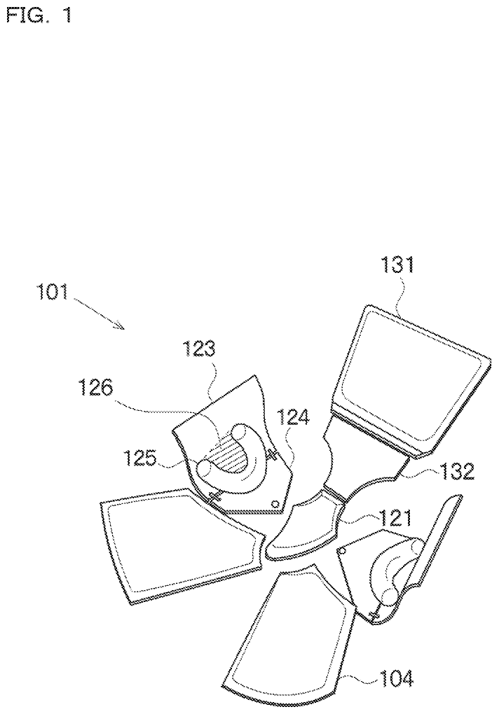

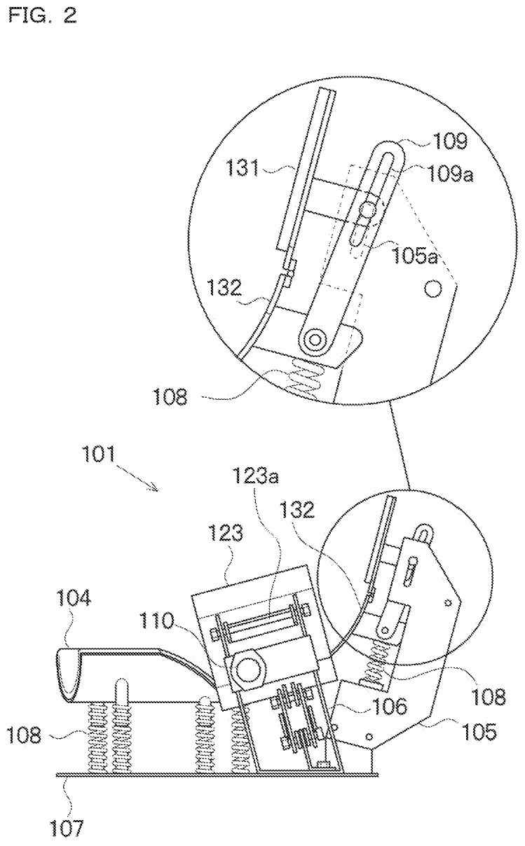

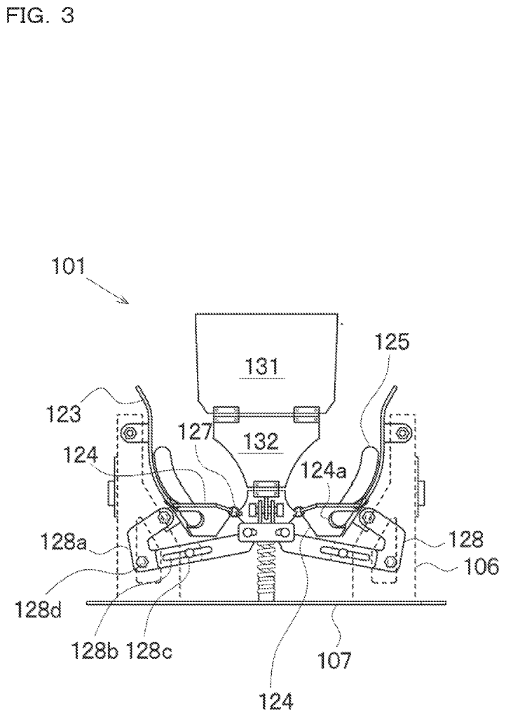

A low back pain treatment device 101 shown in FIGS. 1 through 3 includes a seat (121, 123, 124) for sitting a patient, a backrest (131, 132), a leg rest (104) for placing a thigh, support poles 105 and 106, and a mounting base 107 for mounting the seat, the leg rest (104), and the support poles 105 and 106. The seat, the backrest, and the leg rest 104 are each formed of plate-like metal or resin, and each treatment surface includes a curved surface formed along the body of the patient. The seat, the leg rest 104, and the backrest are liftably and tiltably supported with an elastic body such as a spring 108 and so on.

The back rest includes an upper backrest 131 and a lower backrest 132, which are connected by a hinge. The lower backrest 132 is supported in such a manner to have an inclination smaller than that of the upper backrest 131. The upper backrest 131 is axially supported to a support pole 105 in a slidable manner by means of a slide hole 105a of the support pole 105 and a slide hole 109a of a bracket 109. The lower backrest 132 is axially supported by the bracket 109, and is at the same time supported by the support pole 105 through the spring 108. Therefore, the lower backrest 132 is tilted such that the inclination becomes smaller as the backrest entirely moves downward, and the inclination becomes larger as the backrest entirely moves upward.

The seat includes a bottom part 121 and a pair of side parts (123, 124) that are arranged on both sides of the bottom part 121. The pair of side parts are arranged in a shape gradually widening from the rear side to the front side. At least a part of the treatment surface of the bottom part 121 has a cushioning of a prescribed thickness.

The bottom part 121 are formed in an extending manner from the dorsal side to the ventral side. The bottom part 121 is opposed to a sacrum B2 between a front end 121a and a rear end 121b, and is opposed to a coccyx B3 at the front end 121a. At the front end 121a of the bottom part 121, a curved surface may be formed to wrap around the end of the coccyx B3. The front end 121a and the rear end 121b are supported by the spring 108.

An elastic force of the spring 108 moves the rear end 121b downward when the patient sit on the seat, and the front end 121a receives a relative force in the rising direction to thereby move upward. Here, the distance of downward moving of the rear end 121b is controlled by the elastic force of the spring 108 to be around 5 to 70 mm, preferably to be around 50 mm. As for the spring 108, the most suitable elastic body may be adopted as appropriate, depending on load capacity, for example, in the case used in a patient of heavy weight. Because the downward moving distance is limited, the bottom part 121 can be tilted to just the right extent, and the sacrum B2 and the coccyx B3 can be pushed up to just the right extent.

Each of the pair of side parts includes an upper side section 123 and a lower side section 124, and each of which is opposed to corresponding one of a pair of hipbones B1. The lower side section 124 and the upper side section 123 are tiltably connected to each other. The lower side section 124 is connected to the bottom part 121 by a connecting part (127, 128). The connecting part functions as a linking mechanism to link the movement of the side parts and the movement of the bottom part 121.

The upper side section 123 is rotatably supported by a shaft 123a that is fixed to a support pole 106. Specifically, the shaft 123a is provided in a tilting state where it is elevated from the dorsal side toward the ventral side, and the upper side section 123 is tiltably supported from the dorsal side toward the ventral side.

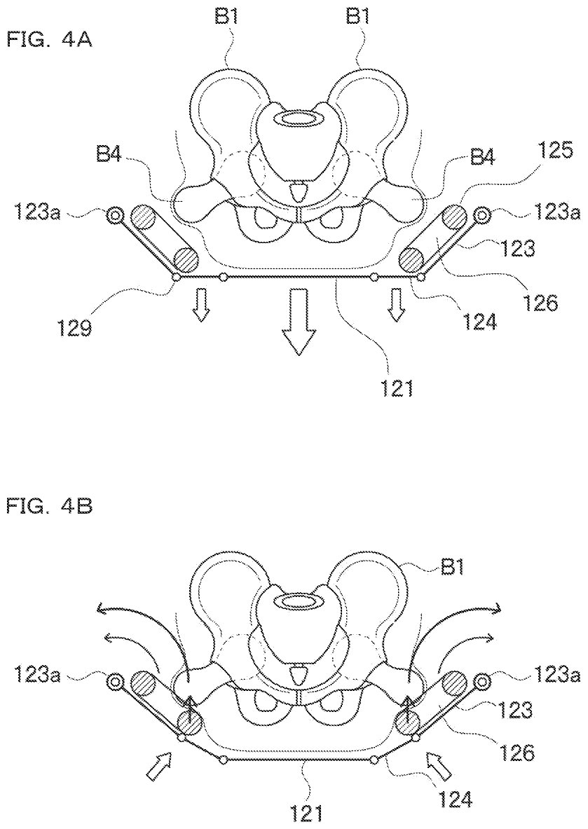

The treatment surface of the upper side section 123 is provided with a nearly U-shaped convex portion 125 having an approximately semicircular cross section, and the lower side section 124 is provided with a notch 124a formed along the shape of the convex portion 125. A folded part of the convex portion 125 serves for the concave portion 126 conforming to the shape of a femoral head B4. The concave portion 126 is arranged at the connecting portion 129 between the upper side section 123 and the lower side section 124 (see FIG. 4). The connecting part 129 is arranged at the position so as to be opposed to the femoral head B4 when the patient sits on the seat. Therefore, the action acts on the piriform muscle and the gluteus maximus around the femoral head B4, and thus, the pelvis including the hipbones B1 can be pressedly extended toward the ventral outside. Further, in the operation, the pain to be caused by interference of the femoral heads B4 with the side parts can be prevented.

The convex portion 125 is arranged to open obliquely upward toward the ventral side. This arrangement enables the femoral head 4 to be smoothly fit into the concave portion 126 when the patient sits on the device. Although a resin material is suitable for a raw material for the convex portion 125, other materials can be used.

The connecting part includes a cord member 127 and an arm 128. The cord member 127 loosely anchors the lower side section 124 to the bottom part 121. With this configuration, when the bottom part 121 is tilted toward the dorsal side, the pair of the lower side parts 124 are pulled toward the bottom part 121. The looseness of the cord member 127 can be adjusted by a dial wire 110.

The arm 128 includes a folded part 128a, a sliding hole 128b, and a link 128c configured to move along the sliding hole, and connects a lower end edge of the upper side section 123 and the rear end 121b of the bottom part 121. When the patient sits, thereby tilting the bottom part 121 toward the dorsal side, the link 128c moves downward along the sliding hole 128b, and the folded part 128a turns around a shaft 128d, thus, the arm 128 operates so as to press the side parts and the convex portion 125 on the patient.

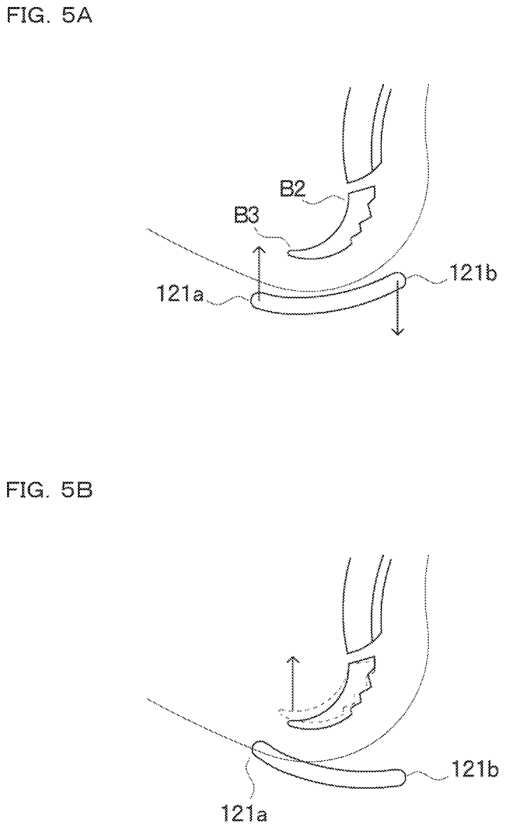

Next, the motion of the lower back pain treatment device 101 having the abovementioned configuration will be described based on FIGS. 4 and 5.

As shown in FIG. 4(a), when the patient sits on the lower back pain treatment device 101 to thereby move the rear end 121b of the bottom part 121 and the lower side section 124 downward, the lower side section 124 is pulled toward both the upper side section 123 and the bottom 122.

Then, as shown in FIG. 4(b), the upper side section 123 is tilted rotatedly around the shaft 123a, so that the entire side parts operate so as to pressedly extend the hipbones B1 toward the ventral outside. At this time, the connecting parts 129 are brought up to come close to the patient, so that the concave portion 126 disposed on the connecting part 129 pressedly extends the femoral head B4 toward the ventral outside, and helps the side parts pressedly extend the hipbones B1 toward the ventral outside.

Meanwhile, as shown in FIG. 5, when the patient sits on the lower back pain treatment device 101, the bottom part 121 is tilted such that the rear end 121b of the bottom part 121 moves downward, and the front end 121a moves upward. A tilting movement of the bottom part 121 causes movements of the sacrum B2 and the coccyx B3 so as to have the posture shown by a broken line, in which the tip of the coccyx B3 is pressedly moved up toward the ventral side. In FIG. 5, the movement widths of the sacrum B2 and the coccyx B3 is exaggerated for the sake of explanation, however, the movements of the sacrum B2 and the coccyx B3 in the actual operation are very slight.

Thus, in the lower back pain treatment device 101 of this embodiment, the tilting movement of the bottom part 121 toward the dorsal side and the tilting movement of the side parts toward the ventral outside from the dorsal side are linked, therefore the operation to pressedly extend the hipbone B1 from the dorsal side toward the ventral outside and the operation to pressedly move up the coccyx B3 toward the ventral side can be linked, so that the sacrum B2 and the coccyx B3, which are fundamentally hard to move due to blocking by the hipbone B1. And, the very slight movement of the sacrum B2 and the coccyx B3 during this time has an effect to relax muscle stress in muscles enveloping the femoral heads and in muscles from the buttocks to the dorsal region through the lumbar region and to improve the low back pain. Furthermore, the bottom part 121 and the side parts connected to the bottom part 121 are restrained from rapidly tilting at this time by controlling the distance of downward moving of the rear end 121b of the bottom part 121 to be around 5 to 70 mm, therefore the bottom part 121 can be moderately tilted to thereby push the sacrum B2 and the coccyx B3 moderately and prevent a burden on the patient in the operation.

### Embodiment 2

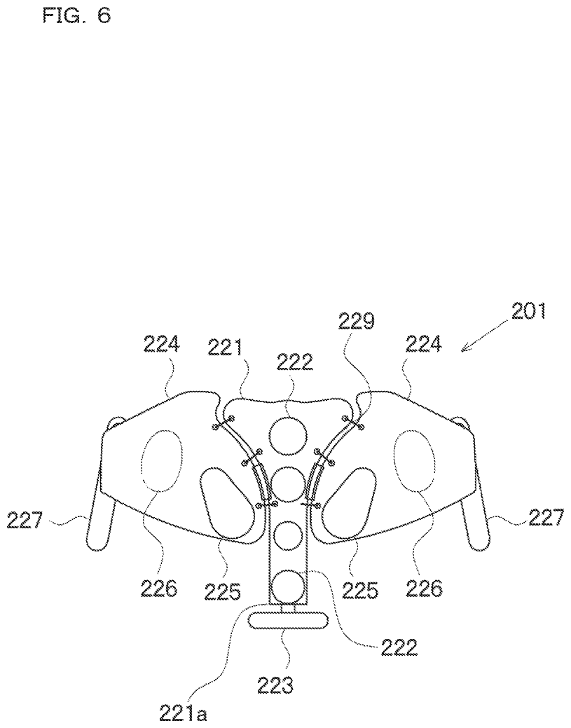

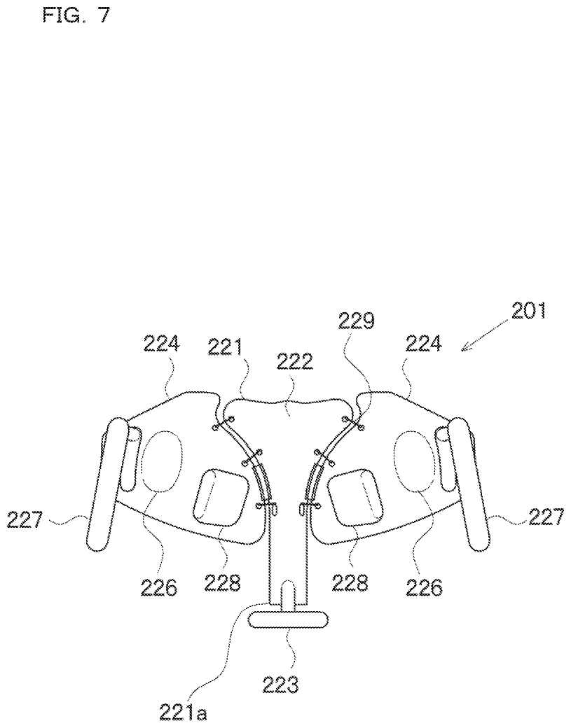

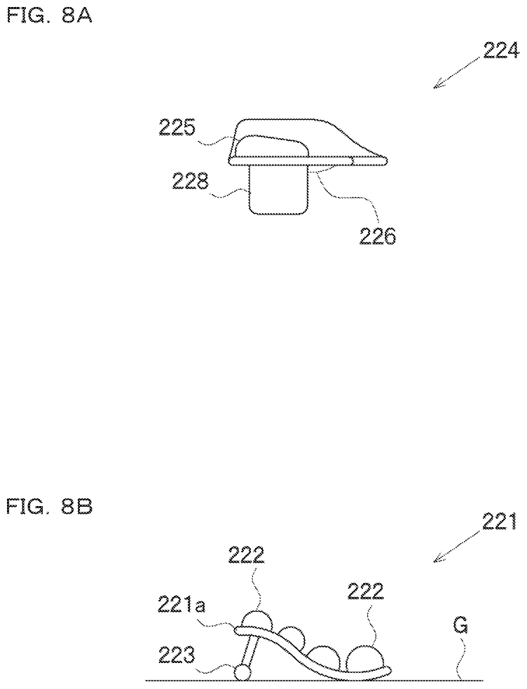

As shown in FIGS. 6 through 8, a lower back pain treatment device 201 includes a seat (221, 224). The seat is formed of plate-like metal or resin, the treatment surface of which includes a curved surface formed along the body of the patient.

The seat includes a bottom part 221, a pair of side parts 224 which are arranged respectively on both sides of the bottom part 221, and a cord member 229 functioning as a linking mechanism to link the pair of side parts 224 and the bottom part 221 by connecting the both. The side parts 224 are loosely anchored to the bottom part 221 by the cord member 229.

The bottom part 221 is formed in an extending manner from the dorsal side to the ventral side along the sacrum B2 and the coccyx B3, and the treatment surface of the bottom part 221 has a plurality of substantially semispherical convex portions 222 formed in the longitudinal direction. In addition, at the front end 221a of the bottom part 221, a curved surface may be formed to wrap around the end of the coccyx B3. The convex portions 222 are arranged so as to be engaged to anatomical concavity and convexity of the sacrum B2 and the coccyx B3. Providing the convex portions 222 enables the bottom part 221 to catch the sacrum B2 and the coccyx B3 without slipping and to suitably push up the end of the coccyx B3 toward the ventral side. The front end 221a of the bottom part 221 has, on a non-treatment surface, a support part 223 for supporting the front end 221a of the bottom part 221 to a placement surface G. The support part 223 operates in such a manner to press the front end 221a on the patient by the reaction force received from the placement surface G.

The side parts 224 respectively include a concave portion 226 along the femoral head B4, an elliptically semispherical convex portion 225 the diameter of which becomes larger from the center to the circumference, a leg 228 which supports the side part 224 to the placement surface G, and a handle 227 for operating the side part 224. The convex portion 225 is provided on the treatment surface, and the leg 223 is arranged at a position opposed to the convex portion 225 on the non-treatment surface. The handle 227 is provided on the side edge of the non-treatment surface.

Here, a pair of the handles 227 and a pair of the legs 228 are provided in a shape gradually widening from the dorsal side to the ventral side. Therefore, when the handle 227 is operated so as to be pressed on the placement surface G, the side part 224 rotates around the grounding point P of the leg 228 as a supporting point. At this time, the treatment surface of the side part 224 operates to pressedly extend the hipbone B1 from the dorsal side to the ventral outside.

The convex portion 225 has a shape complementary to the recess of a buttock. By providing the convex portion 225, the lumbar region of the patient sitting on the device can be guided to a proper position for operation. The concave portion 226 has a shape complementary to the protrusion of the femoral head B4. Providing the concave portion 226 prevents the femoral head B4 from being pressed by the side part 224 whereby preventing a pain to be caused in the femoral head B4.

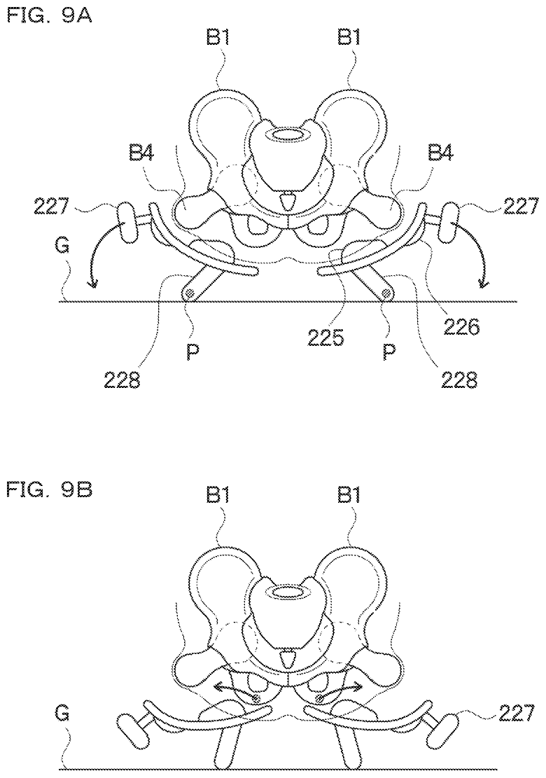

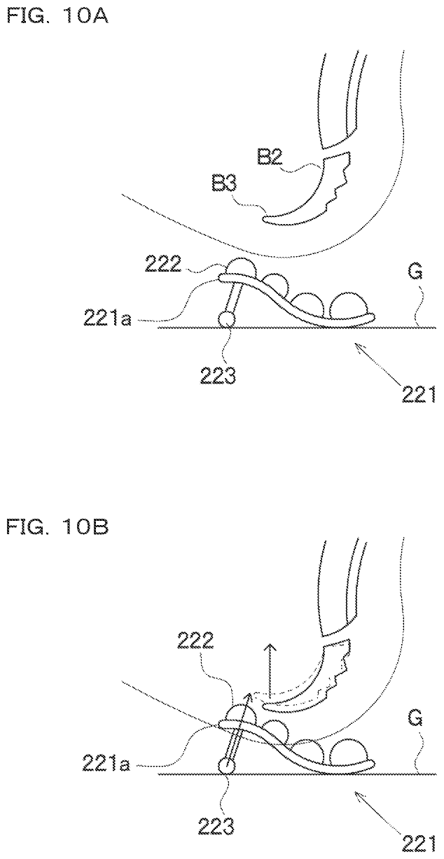

Next, the movement of the lower back pain treatment device 201 having the above-mentioned configuration will be described with reference to FIGS. 9 and 10.

When the patient sits on the device and operates the handle 227 to press it on the placement surface G as shown in FIG. 9(a), each side part 224 tilts to rotate around the grounding point P of the leg 228 as a supporting point, consequently the hipbone B1 is pressedly extended from the dorsal side toward the ventral side by the convex portion 225 as shown in FIG. 9(b). At this time, the femoral heads B4 are respectively opposed to the concave portions 226, therefore, there is no interference with the side parts 224.

At the same time, when the patient sits on the device as shown in FIG. 10, the bottom part 221 is pressed on the placement surface G. At this time, the support part 223 that has received the reaction force from the placement surface G presses the front end 221a of the bottom part 221 on the patient, so that the sacrum B2 and the coccyx B3 are moved so as to have the posture shown by a broken line, and the tip of the coccyx B3 is pressedly moved up toward the ventral side.

In this way, in the lower back pain treatment device 201 of this embodiment, the side parts 224 and the bottom part 221 linkedly move through the cord members 229 by operating the handles 225. Therefore, the operation to pressedly extend the hipbone B1 from the dorsal side toward the ventral outside and the operation to pressedly move up the coccyx B3 toward the ventral side can be linked, so that pelvic treatment effective for lumbago improvement can be performed.

### Embodiment 3

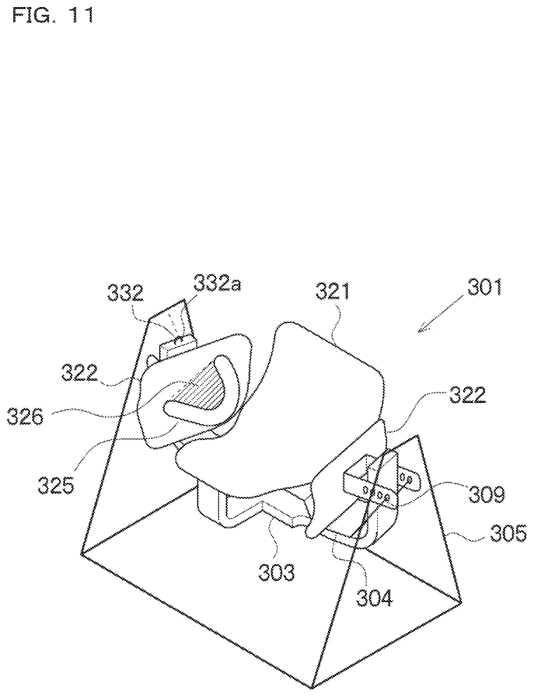

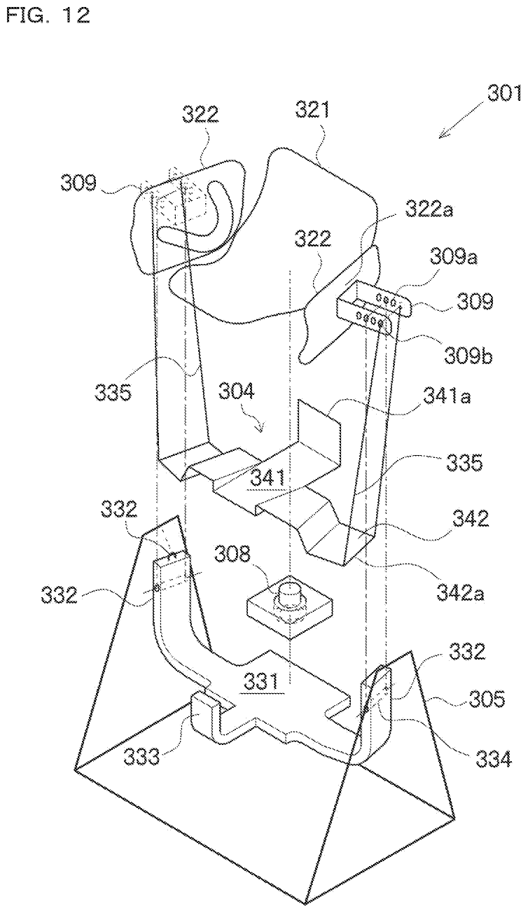

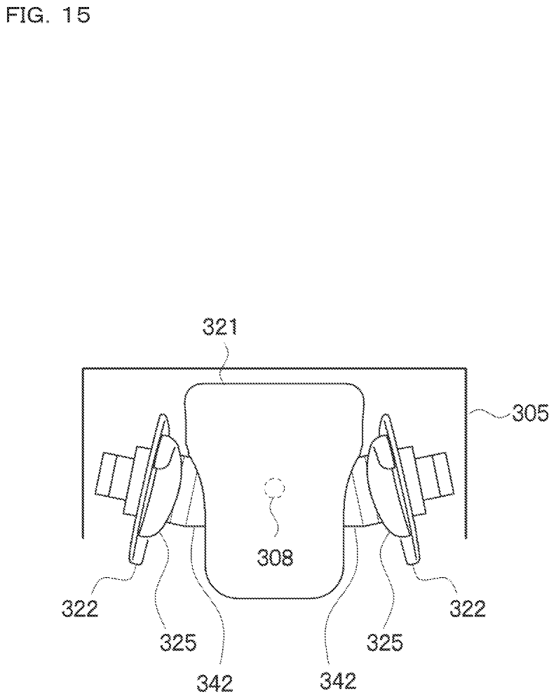

A lower back pain treatment device 301 as shown in FIGS. 11 through 15 includes a seat (321, 322) on which the patient sits, a frame 305 for swingingly supporting the seat, a mounting part 303 for mounting the seat, and an intermediate member 304 disposed between the mounting part 303 and the seat. The seat is formed of plate-like metal or resin, the treatment surface of which includes a curved surface formed along the body of the patient.

The seat includes a bottom part 321, and a pair of side parts 322 which are arranged respectively on both sides of the bottom part 321. The pair of side parts 322 is arranged so as to extend in a shape gradually widening from a dorsal side to a ventral side.

The bottom part 321 is formed along the lumbar region from the dorsal side to the ventral side. The bottom part 321 is provided to be opposed to the sacrum B2 and the coccyx B3 when the patient sits thereon.

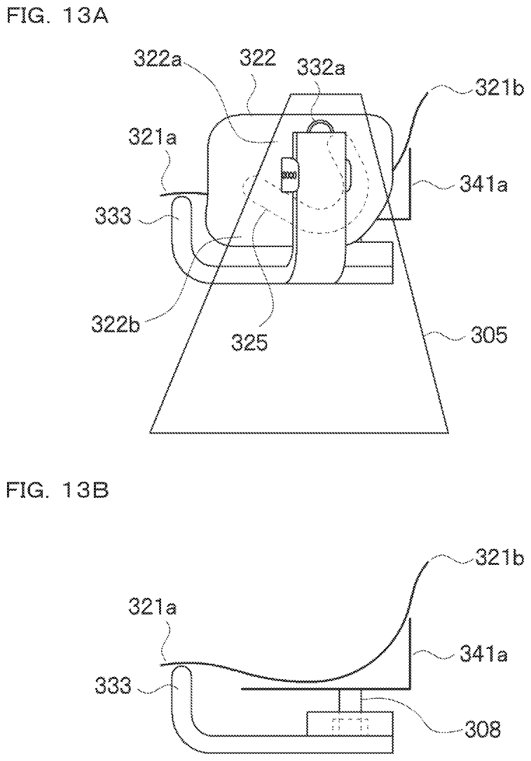

The mounting part 303 includes a main body part 331, arm parts 332 each for rotatably supporting an upper end 322a of the side part 322 around a rod 334, and a leg part 333 for supporting an end 321a on ventral side of the bottom part 321. When the patient sits on the seat, the spring 308 is compressed, and thus the bottom part 321 tilts rotationally with the leg 333 as a supporting point. The upper end of the arm 332 is provided with a hanging part 332a to swingingly hang the mounting part 303 on a frame 305. The main body part 331 has an elastic body such as the spring 308 disposed thereon which supports the seat through the intermediate member 304. Here, the distance of downward moving of an end on ventral side 321b (see FIG. 13) is controlled by the elastic force of the spring 308 to be around 5 to 70 mm, preferably to be around 50 mm. As for the spring 308, the most suitable elastic body may be adopted as appropriate, depending on load capacity, for example, in the case used in a patient of heavy weight. Because the downward moving distance is limited, the bottom part 321 can be tilted to just the right extent, and the sacrum B2 and the coccyx B3 can be pushed up to just the right extent.

The pair of side parts 322 are provided so as to be opposed to a pair of the hipbones B1. The upper end 322a of the non-treatment surface of each side part 322 is equipped with a bracket 309 to attach the side part 322 to the arm 332 of the mounting part 303. The bracket 309 is provided with an adjusting mechanism (adjusting holes 309a) for adjusting the distance between the pair of side parts 322 in accordance with the body size of the patient. Each side part 322 can be attached to the arm part 332 by inserting the rod 334, which has been inserted into the arm part 332, into the adjusting hole 309a. In this configuration, when the rod 334 is inserted into the adjusting hole 309a positioned inside, the distance between the pair of side parts 322 can be adjusted to be wider, meanwhile, when the rod 334 is inserted into the adjusting hole 309a positioned outside, the distance between the pair of side parts 322 can be adjusted to be narrower. The bracket 309 is provided with the attaching holes 309b for attaching the side part 322 to the end part 342a of the intermediate member 304 on its both ends with a wire 335 or the like. In this embodiment, three adjusting holes 309a are provided from the inside, and the attaching hole 309b is provided on the outermost side.

The intermediate member 304 is formed of plate-like metal or resin, and includes a central part 341 extending from the dorsal side to the ventral side and a pair of arm parts 342 extending from the central part 341 to right and left. The central part 341 has, on the dorsal side, a rising part 341a supporting the end on ventral side 321b of the bottom part 321.

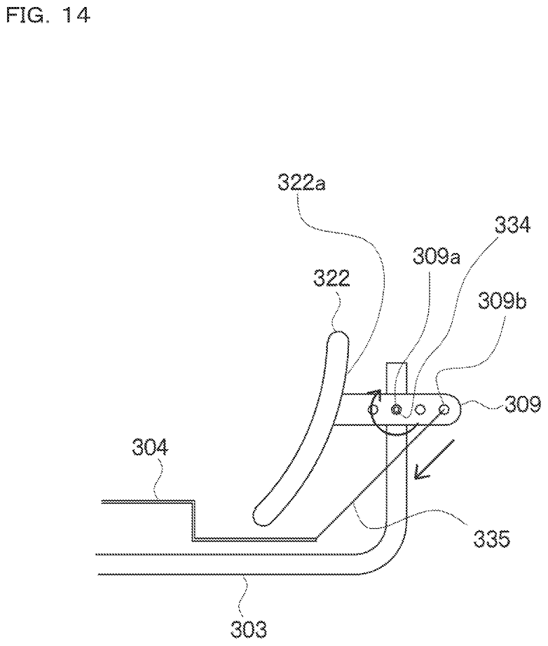

Each arm part 342 of the intermediate member 304 is connected to the side part 322 through the bracket 309. Meanwhile, the central part 341 of the intermediate member 304 is provided between the spring 308 and the bottom part 321. Due to having such a configuration, when the patient sits on the seat to thereby compress the spring 308 to move the intermediate member 304 downward, each arm part 342 of the intermediate member 304 pulls the side part 322 through the wire 335 and the attaching hole 309b of the bracket 309 whereby the side parts 322 tilt to extend to right and left respectively with rotation around the rods 334, as shown in FIG. 14. In this way, the intermediate member 304 functions as a linking mechanism for linking the bottom part 321 and the side parts 322.

The treatment surface of each side part 322 is provided with a nearly U-shaped convex portion 325 having an approximately semicircular cross section. A folded part of the convex portion 325 serves for the concave portion 326 conforming to the shape of a femoral head B4. Therefore, the action acts on the piriform muscle and the gluteus maximus around the femoral head B4, and thus, the pelvis including the hipbones B1 can be pressedly extended toward the ventral outside. Further, in the operation, the pain to be caused by interference of the femoral heads B4 with the side parts 322 can be prevented.

The convex portion 325 is arranged to open obliquely upward toward the ventral side. This arrangement enables the femoral head 4 to be smoothly fit into the concave portion 326 when the patient sits on the device. Although a resin material is suitable for a raw material for the convex portion 325, other materials can be used.

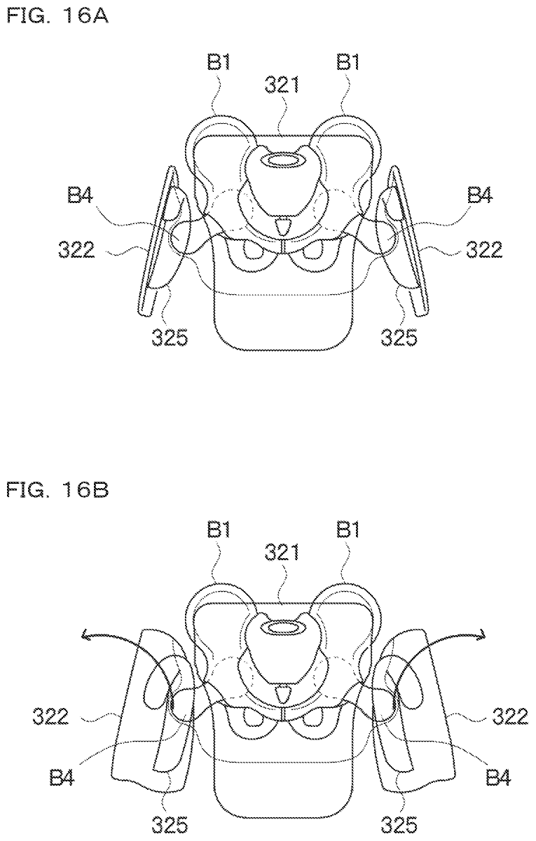

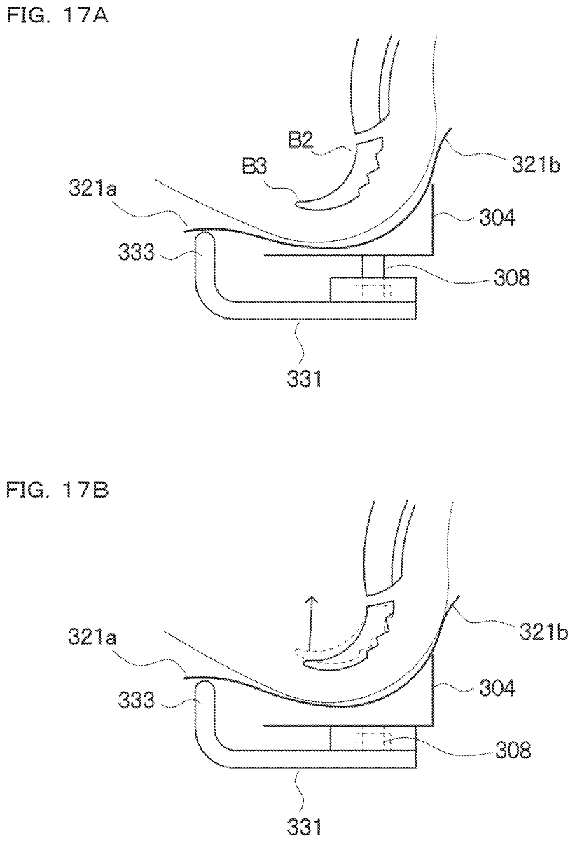

Next, the motion of the lower back pain treatment device 301 having the abovementioned configuration will be described based on FIGS. 16 and 17.

As shown in FIG. 16(a), when the patient sits on the lower back pain treatment device 301 to thereby tilt the bottom part 321 to the dorsal side, the side parts 322 tilt to extend to right and left respectively through the intermediate member 304.

Then, as shown in FIG. 16(b), the entire side parts 322 operate so as to pressedly extend the hipbones B1 toward the ventral outside. At this time, the concave portion 126 pressedly extends the femoral head B4 toward the ventral outside and helps the side parts pressedly extend the hipbones B1 toward the ventral outside.

Meanwhile, as shown in FIG. 17(a), when the patient sits on the lower back pain treatment device 301, the spring 308 is compressed to thereby move the entire intermediate member 304 downward, and thus the bottom part 321 tilts rotationally with the leg 333 of the placement part 303 as a supporting point so that the end on ventral side 321a moves upward relative to the end on dorsal side 321b. By a tilting movement of the bottom part 321, the sacrum B2 and the coccyx B3 are moved so as to have the posture shown by a broken line, and the tip of the coccyx B3 is pressedly moved up toward the ventral side as shown in FIG. 17(b). In FIG. 17, the movement width of the sacrum B2 and the coccyx B3 is exaggerated for the sake of explanation, however, the movement of the sacrum B2 and the coccyx B3 in the actual operation is very slight.

Thus, in the lower back pain treatment device 301 of this embodiment, the tilting movement of the bottom part 321 toward the dorsal side and the tilting movement of the side parts 322 toward the ventral outside from the dorsal side are linked, therefore the operation to pressedly extend the hipbone B1 from the dorsal side toward the ventral outside and the operation to pressedly move up the coccyx B3 toward the ventral side can be linked, so that the sacrum B2 and the coccyx B3, which are fundamentally hard to move due to blocking by the hipbone B1. And, the very slight movement of the sacrum B2 and the coccyx B3 during this time has an effect to relax muscle stress in muscles enveloping the femoral heads and in muscles from the buttocks to the dorsal region through the lumbar region and to improve the low back pain. Furthermore, the bottom part 321 and the side parts 322 connected to the bottom part 321 through the intermediate member 304 are restrained from rapidly tilting at this time by controlling the distance of downward moving of the bottom part 321 to be around 5 to 70 mm, therefore the bottom part 321 can be moderately tilted to thereby push the sacrum B2 and the coccyx B3 moderately and prevent a burden on the patient in the operation.

It is noted that the present disclosure is not limited to the above-mentioned embodiments, and any modification in shape and configuration of each part can be made as appropriate within the scope of the present disclosure.

### EXPLANATION OF NUMERAL REFERENCES

101 Lower back pain treatment device
104 Leg rest
105 Support pole (a: slide hole)
106 Support pole
107 Mounting base
108 Spring
109 Bracket (a: sliding hole)
110 Dial wire
121 Bottom part (a: front end, b: rear end)
123 Upper side section
124 Lower side section (a: notch)
125 Convex portion
126 Concave portion
127 Cord member
128 Arm (a: folded part, b: sliding hole, c: link, d: shaft)
131 Upper backrest
132 Lower backrest
201 Lower back pain treatment device
221 Bottom part (a: front end)
222 Convex portion
223 Support part
224 Side part
225 Convex portion
226 Concave portion
227 Handle
228 Leg
229 Cord member
301 Lower back pain treatment device
303 Mounting part
304 Intermediate member
305 Frame
308 Spring
309 Bracket (a: sliding hole, b: attaching hole)
321 Bottom part (a: end on ventral side, b: end on dorsal side)
322 Side part (a: upper end, b: lower end)
325 Convex portion
326 Concave portion
331 Main body part
332 Arm part (a: hanging part)
333 Leg part
341 Central part
342 Arm part
B1 Hipbone
B2 Sacrum
B3 Coccyx
B4 Femoral head
G Placement surface
P Grounding point

1. A lower back pain treatment device comprising:
a seat for sitting a patient thereon, the seat including:
a bottom part that is opposed to a sacrum and a coccyx of the patient and extends from a dorsal side to a ventral side of the patient; and
a pair of side parts each of which is opposed to corresponding one of a pair of hipbones of the patient; and
a linking mechanism configured to link a movement of the side parts and a movement of the bottom part, wherein
the linking mechanism tilts the side parts in such a manner to open towards both sides when the bottom part is tilted towards the dorsal side.

2. The lower back pain treatment device according to claim 1, wherein the side parts respectively include a concave portion configured to conform to a shape of femoral heads of the patient.

3. The lower back pain treatment device according to claim 2, wherein the side parts respectively include a convex portion, and the concave portion is formed at a part of the convex portion.

4. The lower back pain treatment device according to claim 2, wherein
each of the side parts includes an upper side section and a lower side section that is tiltably connected to the upper side, and
the concave portion is disposed at a connection part between the upper side section and the lower side section and is movable toward the femoral head in response to a tilting movement of the bottom part.

5. The lower back pain treatment device according to claim 3, wherein
each of the side parts includes an upper side section and a lower side section that is tiltably connected to the upper side, and
the concave portion is disposed at a connection part between the upper side section and the lower side section and is movable toward the femoral head in response to a tilting movement of the bottom part.

6. The lower back pain treatment device according to claim 1, further comprising:
an elastic body that tiltably supports the bottom part; and
an arm configured to transmit the tilting movement of the bottom part to the side parts.

7. The lower back pain treatment device according to claim 2, further comprising:
an elastic body that tiltably supports the bottom part; and
an arm configured to transmit the tilting movement of the bottom part to the side parts.

8. The lower back pain treatment device according to claim 3, further comprising:
an elastic body that tiltably supports the bottom part; and
an arm configured to transmit the tilting movement of the bottom part to the side parts.

9. The lower back pain treatment device according to claim 4, further comprising:
an elastic body that tiltably supports the bottom part; and
an arm configured to transmit the tilting movement of the bottom part to the side parts.

10. The lower back pain treatment device according to claim 5, further comprising:
an elastic body that tiltably supports the bottom part; and
an arm configured to transmit the tilting movement of the bottom part to the side parts.
